(19) United States
(12) Patent Application Publication
(10) Pub. No.: US 2013/0270491 A1
(43) Pub. Date: Oct. 17, 2013

(54) CONDUCTIVE HYDROGEL AND METHOD OF PREPARING THE SAME

(71) Applicants: Ik-Ro PARK, Wonju-si (KR); Chan-Moon CHUNG, Wonju-si (KR)

(72) Inventors: Ik-Ro PARK, Wonju-si (KR); Chan-Moon CHUNG, Wonju-si (KR)

(21) Appl. No.: 13/448,968

(22) Filed: Apr. 17, 2012

(51) Int. Cl. H01B 1/12

(52) U.S. Cl. 252/519.3

(57) ABSTRACT

A conductive hydrogel includes: a first monomer; a second monomer; a crosslinking agent; a photoinitiator; a wetting agent; an electrolyte; and deionized water, wherein the first monomer is a 3-sulfopropyl acrylate potassium salt, and the second monomer is acrylic acid. The conductive hydrogel has high adhesivity, conductivity and moisture-retaining capacity and low skin irritancy compared to conventional hydrogels because it has the optimum composition ratio.

### BACKGROUND OF THE INVENTION

1. Technical Field

The present invention relates to a hydrogel, which has high adhesivity, conductivity and moisture-retaining capacity and low skin irritancy compared to conventional hydrogels, and a method of preparing the same.

2. Description of the Related Art

In the medical industry, a conductive hydrogel is widely used as a raw material of accessories used in measuring instruments for diagnoses. Such a conductive hydrogel is used in the electrodes for medical instruments, such as an electrode for an electrocardiogram (ECG), an electrode for an electroencephalogram (EEG), an electrode for an electromyogram (EMG), an electrode for a transdermal electrical nerve stimulator (TENS), a ground electrode for an electrosurgical unit (ESU), and the like, and is a material that enhances in vivo electrical signal transfer.

A conductive hydrogel can be used to attach an electrode to the skin because it has nonpermanent adhesive characteristics and high moisture content and it is treated with an ion-conductive material to improve conductivity. Currently, conductive hydrogels are practically used in various medical accessories for regulating current flow in the human body, such as accessories for physical therapy, electro-surgical accessories and the like, and are also used as a raw material used in measuring instruments for diagnoses. Therefore, the demand for a high-performance hydrogel is gradually increasing.

A high-performance hydrogel must have high conductivity, must have strong adhesivity in order to reduce the noises caused by the shaking and trembling of a patient' body, and must have biological compatibility so as not to cause harmful side effects to the skin because it is directly attached to a patient's skin.

Meanwhile, methods of preparing medical hydrogels have become more advanced. That is, in order to compensate for the disadvantages of a conventional chemical crosslinking method, a UV crosslinking method using a radiation technology has been developed.

The conventional chemical crosslinking method is disadvantageous in that a harmful chemical crosslinking agent is used, the crosslinking agent remaining behind after crosslinking must be removed, a lot of time is required, and the viscoelasticity of a hydrogel is not high due to complex ion bonds. However, the UV crosslinking method using radiation technology is advantageous in that it the residual crosslinking agent does not have to be removed and there is no need to perform an additional sterilization process, the crosslinking can be conducted for a short period of time (several tens of seconds), and the hydrogel prepared by this method can more effectively detect biological signals because it has excellent adhesivity and holding force due to strong covalent bonds. Accordingly, various types of hydrogels are being developed using the UV crosslinking method.

Korea Unexamined Patent Publication No. 2007-0085460 discloses a hydrogel composition including N-vinyl pyrrolidone as a first monomer. N-vinyl pyrrolidone is used as a major raw material of a contact lens, and is a monomer having transparency and hydrophilicity. Therefore, when a hydrogel is prepared using N-vinyl pyrrolidone as a monomer, there is an advantage in that the polymerization condition is relatively simple because this monomer has a vinyl group, but there is a disadvantage in that the conductivity and adhesivity of the prepared hydrogel become low because this monomer is not a salt.

U.S. Patent Publication No. 2008-0064839 discloses a composition including a 3-sulfopropyl acrylate potassium salt as a hydrophilic monomer. This composition is suitable for use as a material used in surgical operations, but is not a suitable conductive hydrogel composition which has conductivity and adhesivity.

However, the above-mentioned technologies do not satisfy the demands for a conductive hydrogel having biological compatibility as well as excellent adhesivity and conductivity, and do not provide the optimum composition ratio which can be directly put to practical use in the related technical field.

### SUMMARY OF THE INVENTION

Accordingly, the present invention has been devised to solve the above-mentioned problems, and an object of the present invention is to provide a conductive hydrogel which is prepared by a UV crosslinking process, which includes 3-sulfopropyl acrylate potassium salt as a first monomer and acrylic acid as a second monomer to provide the optimum composition ratio, which has high adhesivity, conductivity and moisture-retaining capacity and low skin irritancy, and which can be directly put to practical use in the related technical field.

In order to accomplish the above object, an aspect of the present invention provides a conductive hydrogel, including: a first monomer; a second monomer; a crosslinking agent; a photoinitiator; a wetting agent; an electrolyte; and deionized water, wherein the first monomer is a 3-sulfopropyl acrylate potassium salt, and the second monomer is acrylic acid.

Here, the crosslinking agent may be selected from the group consisting of ethyleneglycol dimethacrylate, poly(ethyleneglycol) diacrylate, diethyleneglycol dimethacrylate, ethyleneglycol diacrylate, 1,3-dihydroxypropyl dimethacrylate and mixtures thereof.

Further, the photoinitiator may be selected from the group consisting of 1-hydroxycyclohexyl phenyl ketone, monoacyl phosphine oxide, benzoyl alkyl ether, mercaptobenzothiazoyl and mixtures thereof.

Further, the wetting agent may be glycerol.

Further, the electrolyte may be selected from the group consisting of sodium, potassium chloride, phosphate, citrate, acetate and lactate.

Further, the amount of the 3-sulfopropyl acrylate potassium salt may be 24˜32 wt %, the amount of the acrylic acid may be 1˜4 wt %, the amount of the crosslinking agent may be 0.06˜0.1 wt %, the amount of the photoinitiator may be 0.01˜0.1 wt %, the amount of the wetting agent may be 32˜40 wt %, the amount of the electrolyte may be 2.5˜3.5 wt %, and the amount of the deionized water may be 28˜35 wt %.

Preferably, the crosslinking agent may be poly(ethyleneglycol) diacrylate, the photoinitiator may be 1-hydroxycyclohexyl phenyl ketone, the wetting agent may be glycerol, and the electrolyte may be potassium chloride. In this case, the amount of the 3-sulfopropyl acrylate potassium salt may be 24˜32 wt %, the amount of the acrylic acid may be 3˜4 wt %, the amount of the poly(ethyleneglycol) diacrylate may be 0.08˜0.1 wt %, the amount of the 1-hydroxycyclohexyl phenyl ketone may be 0.08˜0.1 wt %, the amount of the glycerol may be 35˜40 wt %, the amount of the potassium chloride may be 2.5˜3.0 wt %, and the amount of the deionized water may be 28˜32 wt %. When the conductive hydrogel has this composition ratio, it can have excellent physical properties such as conductivity, adhesivity and the like.

The conductive hydrogel may further include at least one additive selected from the group consisting of a moisture-retaining agent, an enzyme, a surfactant, an antibiotic, a permeation enhancer, a pH adjuster, and mixtures thereof.

Another aspect of the present invention provides a method of preparing the conductive hydrogel, including the steps of: mixing the first monomer, the second monomer, the crosslinking agent, the photoinitiator, the wetting agent and the electrolyte with the deionized water and stirring the mixture to prepare a composition; and irradiating the composition with ultraviolet to crosslink the composition.

### DESCRIPTION OF THE PREFERRED EMBODIMENTS

Hereinafter, preferred embodiments of the present invention will be described in detail with reference to the attached drawings.

The conductive hydrogel according to the present invention includes: a first monomer; a second monomer; a crosslinking agent; a photoinitiator; a wetting agent; an electrolyte; and deionized water, wherein the first monomer is a 3-sulfopropyl acrylate potassium salt, and the second monomer is acrylic acid.

A conductive hydrogel must have physical properties, such as ion transfer characteristics for transferring biosignals, adhesivity for adhering the hydrogel to the skin surface, maintenance for maintaining the hydrogel for about 24 hours after adhering it to the surface of skin, a moisture-retaining property for preventing the hydrogel from drying, biological compatibility for preventing the hydrogel from stimulating the skin when applying the hydrogel to the skin, and the like. Generally, a hydrogel has a three-dimensional mesh structure such that it can contain a large amount of moisture.

Further, a hydrogel is characterized in that it does not dissolve in water. Although a hydrogel somewhat involves itself in electrostatic and lipophilic interactions, it does not dissolve in water and can maintain its shape because there are covalent bonds between the main polymer chains. In other words, a hydrogel exhibits mechanical properties and maintains its shape while it absorbs water with it insoluble in water.

In order to increase the conductivity of a hydrogel, in the present invention, a 3-sulfopropyl acrylate potassium salt is used as a first monomer, and acrylic acid is used as a second monomer.

The 3-sulfopropyl acrylate potassium salt, which is used as the first monomer of the present invention, acts as a main chain for forming a structure of a hydrogel. The 3-sulfopropyl acrylate potassium salt is a water-soluble anionic monomer, and has self-conductivity. Further, the 3-sulfopropyl acrylate potassium salt can be used to introduce polar sites into a polymer chain, and can be used to provide shear stability to a water-soluble polymer in the dispersion of the water-soluble polymer. When a hydrogel is polymerized using the 3-sulfopropyl acrylate potassium salt, the hydrogel polymerizes very rapidly within 60 seconds, and has excellent self-adhesivity.

The amount of the 3-sulfopropyl acrylate potassium salt may be 24˜32 wt %, and preferably 24˜30 wt %. When the amount of the 3-sulfopropyl acrylate potassium salt is less than 24 wt %, the amount of a wetting agent in the hydrogel is relatively increased in relation to other components of the hydrogel, and thus the hydrogel may become weak. Further, when the amount thereof is more than 32 wt %, potassium chloride may be deposited.

The acrylic acid serves to adjust the pH, and is a component necessary for polymerization. Therefore, when the acrylic acid is not added, a polymerization reaction may not occur. Further, when the hydrogel is prepared using the 3-sulfopropyl acrylate potassium salt as a first monomer and using the acrylic acid as a second monomer, the polymerization reactivity thereof can be improved, the pH thereof can be easily adjusted, and the moisture-retaining property thereof can be improved.

The amount of the acrylic acid may be 1˜4 wt % (in this case, the pH of the hydrogel is 3.5˜4.5), and preferably 3˜4 wt %, considering the composition ratio thereof relative to that of other components. When the amount of the acrylic acid is less than 1 wt %, polymerization does not take place easily. Further, the amount thereof is more than 4 wt %, the pH of the hydrogel is 3˜3.2, that is, the acidity of the hydrogel is excessively high, and thus the hydrogel may stimulate the skin.

The present invention provides a method of preparing a hydrogel by radiation crosslinking using ultraviolet irradiation. Therefore, in order to prepare a hydrogel, a photoinitiator and a crosslinking agent are added.

Generally, a thermoinitiator or a photoinitiator, which is respectively sensitive to heat or light, may be used as an initiator. However, in the present invention, preferably, a radical polymerization initiator using UV irradiation may be used to prepare a hydrogel.

The photoinitiator may be selected from the group consisting of 1-hydroxycyclohexyl phenyl ketone, monoacyl phosphine oxide, benzoyl alkyl ether, mercaptobenzothiazoyl and mixtures thereof, but is not limited thereto. Among them, 1-hydroxycyclohexyl phenyl ketone may be preferably used as the photoinitiator. Since the photoinitiator participates in the initial reaction, the amount thereof may be 0.01˜0.1 wt %, and preferably 0.08˜0.1 wt %.

Further, the hydrogel of the present invention includes a crosslinking agent. The crosslinking agent is a polymer connecting oligomers to form a three-dimensional mesh structure. In the preparation of the hydrogel, when the crosslinking agent is not added, gelation does not proceed.

The crosslinking agent may be selected from the group consisting of ethyleneglycol dimethacrylate, poly(ethyleneglycol) diacrylate, diethyleneglycol dimethacrylate, ethyleneglycol diacrylate, 1,3-dihydroxypropyl dimethacrylate and mixtures thereof, but is not limited thereto. Among them, (poly(ethylene glycol) diacrylate may be preferably used as the crosslinking agent.

When the amount of the crosslinking agent is 0.06˜0.1 wt %, good crosslinkability is exhibited, and, when the amount thereof is 0.08˜0.1 wt %, the best crosslinkability is exhibited. When the amount of the crosslinking agent is less than 0.06 wt %, gelation proceeds, but the hydrogel may break. Further, the amount of the crosslinking agent is more than 0.1 wt %, gelation proceeds, but the adhesivity of the hydrogel may decrease.

The hydrogel of the present invention includes an electrolyte. The electrolyte serves to decrease electrical resistance and increase conductivity. An ionic inorganic salt or an organic compound may be used as the electrolyte. The electrolyte may be selected from the group consisting of sodium, potassium chloride, phosphate, citrate, acetate and lactate, but is not limited thereto. Among these electrolytes, potassium chloride may be preferably used for the sake of the uniformity of compounds because the first monomer used in the present invention is a 3-sulfopropyl acrylate potassium salt, which is a potassium salt.

When the amount of the electrolyte is less than 2 wt %, the conductivity of the hydrogel is improved, but is improved very small when compared to that of a hydrogel obtained when only a monomer is used. Further, when the amount thereof is more than 4 wt %, the conductivity of the hydrogel is improved, but the electrolyte may be redeposited in the form of a salt. Furthermore, when an excess amount of the electrolyte is added, the viscosity of the hydrogel may decrease. Therefore, the amount of the electrolyte may be 2.0˜3.5 wt %, preferably 2.5˜3.5 wt %, and more preferably 2.5˜3.0 wt %.

The hydrogel of the present invention includes a wetting agent. The wetting agent is used to increase the moisture-retaining capacity of the hydrogel. As the wetting agent, the use of glycerol is preferable.

The 3-sulfopropyl acrylate potassium salt, which is a monomer used to prepare the hydrogel of the present invention, has self moisture-retaining capacity. However, since glycerol is cheap compared to the monomer, it is preferred in terms of reducing the unit production cost of the hydrogel that the composition ratio, at which the total production cost of the hydrogel can be reduced and the glycerol can exhibit the same effect as that of a 3-sulfopropyl acrylate potassium salt, be ascertained by increasing the amount of the glycerol.

As the amount of the glycerol increases, the adhesivity of the hydrogel increases, but a small amount of the glycerol sticks to the hydrogel. When the amount thereof decreases to 30 wt %, the moisture-retaining property of the hydrogel is deteriorated, and potassium chloride may be deposited. Therefore, the amount of the glycerol may be 32˜40 wt %, and preferably 35˜40 wt %.

Water is a generally-used solvent. In the present invention, deionized water is used as the solvent, and the deionized water serves as a plasticizer of a polymer. The deionized water is a component influencing the osmotic pressure, swelling and viscoelasticity. Triple distilled water or quadruple distilled water can be used.

Different amounts of the deionized water may be used. The amount thereof is generally varied depending on the amount of the first monomer and the second monomer. In the present invention, when the amount of the deionized water is 10 wt % or less, the amount thereof is insufficient to dissolve the monomers, and thus a uniform hydrogel cannot be obtained, which is undesirable. Meanwhile, when the amount of the deionized water is 50 wt % or more, the amount of the wetting agent becomes relatively low, and thus the hydrogel dries easily. Therefore, the amount of the deionized water may be 25˜40 wt %, preferably 28˜35 wt %, and more preferably 28˜32 wt %.

For example, the conductive hydrogel of the present invention may include 24˜32 wt % of a 3-sulfopropyl acrylate potassium salt, 1˜4 wt % of acrylic acid, 0.06˜0.1 wt % of a crosslinking agent, 0.01˜0.1 wt % of a photoinitiator, 32˜40 wt % of a wetting agent, 2.5˜3.5 wt % of an electrolyte, and 28˜35 wt % of deionized water.

More preferably, the conductive hydrogel of the present invention may include 24˜30 wt % of a 3-sulfopropyl acrylate potassium salt, 3˜4 wt % of acrylic acid, 0.08˜0.1 wt % of a crosslinking agent, 0.08˜0.1 wt % of a photoinitiator, 35˜40 wt % of a wetting agent, 2.5˜3.0 wt % of an electrolyte, and 28˜32 wt % of deionized water. Here, the crosslinking agent may be poly(ethyleneglycol) diacrylate, the photoinitiator may be 1-hydroxycyclohexyl phenyl ketone, the wetting agent may be glycerol, and the electrolyte may be potassium chloride.

The conductive hydrogel of the present invention may further include at least one additive selected from the group consisting of a moisture-retaining agent, an enzyme, a surfactant, an antibiotic, a permeation enhancer, a pH adjuster, and mixtures thereof.

The hydrogel can be polymerized by an optical crosslinking process in which the composition having the above-mentioned composition ratio is irradiated with ultraviolet to crosslink the composition. In the formation of the composition, when deionized water is added and then a first monomer is added, the first monomer conglomerates before it dissolves in the deionized water. Therefore, a uniform composition can be obtained by combining the composition in the order of a crosslinking agent, a first monomer, an electrolyte, a wetting agent, deionized water and a second monomer. Thereafter, the composition is stirred for 30˜40 minutes, the length of which is increased as the amount of the deionized water is decreased. A photoinitiator is finally added because a polymerization reaction may previously occur if it were to be initially added together with the other components. Then, the composition is further stirred for about 10 minutes. Thereafter, the composition may be ultrasonically treated or vacuum-treated at low pressure in order to remove air bubbles formed by the stirring. Subsequently, the composition is poured into a mold, and is then irradiated for 60 seconds using a UV lamp. The cure degree of the composition can be controlled by the irradiation time or irradiation intensity of the UV lamp. It is preferred that the irradiation rate of ultraviolet be 1200 mJ/cm² or more. The polymerization of the hydrogel is not limited thereto.

Hereinafter, the present invention will be described in more detail with reference to the following Examples. These Examples are set forth to illustrate the present invention, and the scope of the present invention is not limited thereto.

### EXAMPLES

The specifications of the component used in Examples 1 to 4 and Comparative Examples 1 to 8 are as follows.

(A) 3-sulfopropyl acrylate potassium salt: 3-sulfopropyl acrylate potassium salt (brand name: 251631), manufactured by Aldrich Corp., was used.

(A′) N-vinyl pyrrolidone: 1-ethyl-2-pyrrolidone (brand name: 146358), manufactured by Aldrich Corp., was used.

(A″) [2-(methacryloyloxy)ethyl]trimethylammonium chloride: [2-(methacryloyloxy)ethyl]trimethylammonium chloride (brand name: 408107), manufactured by Aldrich Corp., was used.

(B) Acrylic acid: acrylic acid 99% anhydrous (brand name: 147230), manufactured by Aldrich Corp., was used.

(C) Poly(ethyleneglycol) diacrylate: poly(ethyleneglycol) diacrylate (brand name: 437441), manufactured by Aldrich Corp., was used.

(D) Glycerol: glycerol 99.5+% ACS (brand name: G7893), manufactured by Sigma Aldrich Corp., was used.

(E) Potassium chloride: potassium chloride 99.0˜100.5% ACS (brand name: G7893), manufactured by Sigma Aldrich Corp., was used.

(F) 1-hydroxycyclohexyl phenyl ketone: 1-hydroxycyclohexyl phenyl ketone (brand name: 405612), manufactured by Aldrich Corp., was used.

(G) Deionized water: triple distilled water was used.

### Examples 1 to 4

The above-mentioned components were mixed at the mixing ratio given in Table 1 below in the order of poly(ethyleneglycol) diacrylate, 3-sulfopropyl acrylate potassium salt, potassium chloride, glycerol, deionized water and acrylic acid to obtain a composition. The composition was stirred for 30˜40 minutes. Subsequently, 1-hydroxycyclohexyl phenyl ketone was added to the composition and then stirred for about 10 minutes.

Thereafter, the composition was ultrasonically treated to remove air bubbles caused by the stirring. Then, the composition was poured into a mold, and was then irradiated for 60 seconds using a UV lamp. As the UV lamp, a high-pressure mercury lamp having a wavelength of 300 nm was used. Thus, hydrogel samples, each having a diameter of 15 mm and a thickness of 1 mm, were obtained.

### Comparative Examples 1 to 8

Hydrogel samples was obtained in the same manner as in each of Examples 1 to 4, except that all the components were mixed at the mixing ratio given in Table 1 below without relation to the order.

TABLE 1

| | Examples | | | | Comparative Examples | | | | | | | |
|---|---|---|---|---|---|---|---|---|---|---|---|---|
| Components | 1 | 2 | 3 | 4 | 1 | 2 | 3 | 4 | 5 | 6 | 7 | 8 |
| (A) 3-sulfopropyl | 24.0 | 30.0 | 26.0 | 28.0 | 30.0 | 30.0 | — | — | — | 22.0 | — | 30.0 |
| acrylate potassium salt | | | | | | | | | | | | |
| (A′) N-vinyl pyrrolidone | — | — | — | — | — | — | 30.0 | 20.0 | — | — | 30.0 | — |
| (A″) [2- | — | — | — | — | — | — | — | — | 30.0 | — | — | — |
| (methacryloyloxy)ethyl]trimethyl | | | | | | | | | | | | |
| ammonium | | | | | | | | | | | | |
| chloride | | | | | | | | | | | | |
| (B) acrylic acid | 4.0 | 4.0 | 4.0 | 4.0 | 5.0 | 4.0 | — | 4.0 | 4.0 | 4.0 | 4.0 | 4.0 |
| (C) poly(ethylene | 0.1 | 0.1 | 0.1 | 0.1 | 0.1 | 0.1 | 0.1 | 0.2 | 0.1 | 0.1 | 0.1 | 0.1 |
| glycol) diacrylate | | | | | | | | | | | | |
| (D) glycerol | 40.0 | 34.0 | 38.0 | 36.0 | 40.0 | 34.5 | 40.0 | 41.7 | 40.0 | 36.0 | 34.0 | 30.5 |
| (E) potassium chloride | 2.5 | 2.5 | 2.5 | 2.5 | 4.0 | 2.0 | 4.0 | 4.0 | 2.5 | 2.5 | 2.5 | 4.0 |
| (F) 1-hydroxycyclohexyl | 0.1 | 0.1 | 0.1 | 0.1 | 0.1 | 0.1 | 0.1 | 0.1 | 0.1 | 0.1 | 0.1 | 0.1 |
| phenyl ketone | | | | | | | | | | | | |
| (G) deionized water | 29.3 | 29.3 | 29.3 | 29.3 | 20.8 | 29.3 | 25.8 | 30 | 23.3 | 35.3 | 29.3 | 31.3 |

### Test Examples

The physical properties of the hydrogel samples were measured by the following method, and the results thereof are given in Table 1 below.

(1) Adhesivity: the adhesivity of each of the hydrogel samples was measured by 180° Peel test according to the ASTM D3330 standards. The final test result thereof was evaluated by the average value of five test results. The unit of adhesivity is kg/inch.

(2) pH: the final pH of each of the hydrogel samples was measured using a pH meter after constituting the hydrogel composition.

(3) Impedance: the conductivity of each of the hydrogel samples was evaluated by conducting an impedance test, which is an electrical performance test, at a frequency of 10 Hz. It was seen that the conductivity thereof becomes high as the impedance thereof become low.

(4) Whether or not potassium chloride was deposited: whether or not potassium chloride crystals were deposited on each of the hydrogel samples after each of the hydrogel samples had been dried was observed with the naked eye.

(5) Moisture-retaining capacity: the moisture-retaining capacity of each of the hydrogel samples was evaluated by performing an accelerated life test (wherein the lifecycle of a product is calculated by regarding the product as having been kept for 4.6 weeks at 70 according to the acceleration theory (ASTM TIR-17) for a product having been kept for 2 years) and then an electrical performance test was conducted.

### Evaluation Standards of Moisture-retaining Capacity

Good: the hydrogel sample was sticky when touched with the hand, and the final impedance value of the hydrogel sample was not different from the initial impedance value thereof (2kΩ or less) at the time of the impedance test.

Poor: the hydrogel sample was not sticky when touched with the hand, and the final impedance value of the hydrogel sample was greatly different from the initial impedance value thereof (2kΩ or more) at the time of the impedance test.

TABLE 2

| Physical | Examples | | | | Comparative Examples | | | | | | | |
|---|---|---|---|---|---|---|---|---|---|---|---|---|
| properties | 1 | 2 | 3 | 4 | 1 | 2 | 3 | 4 | 5 | 6 | 7 | 8 |
| Adhesivity | 0.27 | 0.24 | 0.27 | 0.26 | 0.25 | 0.25 | — | 0.15 | 0.15 | 0.15 | 0.14 | 0.20 |
| (kg/inch) | | | | | | | | | | | | |
| pH | 3.5 | 3.4 | 3.4 | 3.5 | 3.0 | 3.4 | — | 3.5 | 3.4 | 3.4 | 3.5 | 3.4 |
| Impedance | 90~120 | 100~120 | 100~130 | 110~130 | 100~120 | 250~300 | not | 20,000 | 300~350 | 120~140 | 20,000 | 90~110 |
| (Ω) | | | | | | | polymerized | or | | | or | |
| | | | | | | | | more | | | more | |
| Potassium | X | X | X | X | ◯ | X | — | ◯ | X | X | X | ◯ |
| chloride | | | | | | | | | | | | |
| deposited | | | | | | | | | | | | |
| or not | | | | | | | | | | | | |
| Moisture- | good | good | good | good | good | good | — | poor | good | poor | poor | poor |
| retaining | | | | | | | | | | | | |
| capacity | | | | | | | | | | | | |

As given in Table 2 above, it can be seen that the adhesivity and conductivity of a hydrogel are improved when a 2-sulfopropyl acrylate potassium salt and acrylic acid are simultaneously used according to the present invention compared to when only N-vinyl pyrrolidone is used or when [2-(methacryloyloxy)ethyl]trimethylammonium chloride and acrylic acid are simultaneously used. Further, it can be seen that the adhesivity, conductivity, moisture-retaining capacity of a hydrogel are high and that the irritancy to the skin thereof becomes low when the composition ratios of the components included in the hydrogel of the present invention are those of Examples 1 to 4.

As shown in Comparative Example 3, it can be seen that, when only N-vinyl pyrrolidone was used as a monomer, polymerization did not occur, and thus acrylic acid (second monomer) was an essential component. Further, as shown in Comparative Example 5, it can be seen that, although acrylic acid was used as a monomer, the adhesivity and conductivity of the hydrogel became far better when a 3-sulfopropyl acrylate potassium salt was used as a first monomer compared to when [2-(methacryloyloxy)ethyl]trimethylammonium chloride was used as the first monomer.

Moreover, comparing Comparative Example 7 and Example 2 which have identical composition ratios, the second monomers thereof are identical to each other and the first monomers thereof are different from each other, it can be seen that the adhesivity, conductivity and moisture-retaining capacity of a hydrogel are improved when a 3-sulfopropyl acrylate potassium salt was used as a first monomer.

In the present invention, it can be seen that the adhesivity, conductivity and moisture-retaining capacity of a hydrogel are influenced by the composition ratio of the components included in the hydrogel. The hydrogel of Comparative Example 1, which includes 4 wt % of acrylic acid, can stimulate the skin because its pH is 3.0. Further, the conductivity of the hydrogel of each of Examples 1 to 4, which includes 2.5 wt % of potassium chloride, is higher than that of the hydrogel of Comparative Example 2, which includes 2.0 wt % or less of potassium chloride.

Further, comparing the composition ratios of the hydrogels of Examples 1 to 4 with that of the hydrogel of Comparative Example 6, which includes a first monomer in an amount of less than 24 wt %, it can be seen that the adhesivity, conductivity and moisture-retaining capacity of the hydrogel of each of Examples 1 to 4 are higher than those of the hydrogel of Comparative Example 6. Moreover, as shown in Comparative Example 8, it can be seen that, when the hydrogel includes 4 wt % of potassium chloride and less than 32 wt % of glycerol, its conductivity is good, but its moisture-retaining capacity becomes low, and potassium chloride is redeposited.

Consequently, from the above results, it can be ascertained that the conductive hydrogel of the present invention has excellent physical properties compared to conventional hydrogels.

As described above, the conductive hydrogel according to the present invention is advantageous in that it easily adheres to the skin, and in that it is biologically compatible because it more easily transfers electrical signals and impulses and has high moisture-retaining capacity and low irritancy to the skin.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A conductive hydrogel, comprising:
a first monomer; a second monomer; a crosslinking agent; a photoinitiator; a wetting agent; an electrolyte; and deionized water,
wherein the first monomer is a 3-sulfopropyl acrylate potassium salt,
the second monomer is acrylic acid,
the crosslinking agent is selected from the group consisting of ethyleneglycol dimethacrylate, poly(ethyleneglycol) diacrylate, diethyleneglycol dimethacrylate, ethyleneglycol diacrylate, 1,3-dihydroxypropyl dimethacrylate and mixtures thereof,
the photoinitiator is selected from the group consisting of 1-hydroxycyclohexyl phenyl ketone, monoacyl phosphine oxide, benzoyl alkyl ether, mercaptobenzothiazoyl and mixtures thereof,
the wetting agent is glycerol, and
the electrolyte is selected from the group consisting of sodium, potassium chloride, phosphate, citrate, acetate and lactate.

2. The conductive hydrogel according to claim 1, wherein an amount of the 3-sulfopropyl acrylate potassium salt is 24˜32 wt %, an amount of the acrylic acid is 1˜4 wt %, an amount of the crosslinking agent is 0.06˜0.1 wt %, an amount of the photoinitiator is 0.01˜0.1 wt %, an amount of the wetting agent is 32˜40 wt %, an amount of the electrolyte is 2.5˜3.5 wt %, and an amount of the deionized water is 28˜35 wt %.

3. The conductive hydrogel according to claim 1, wherein the crosslinking agent is poly(ethyleneglycol) diacrylate, the photoinitiator is 1-hydroxycyclohexyl phenyl ketone, and the electrolyte is potassium chloride.

4. The conductive hydrogel according to claim 3, wherein an amount of the 3-sulfopropyl acrylate potassium salt is 24˜32 wt %, an amount of the acrylic acid is 3˜4 wt %, an amount of the poly(ethyleneglycol) diacrylate is 0.08˜0.1 wt %, an amount of the 1-hydroxycyclohexyl phenyl ketone is 0.08˜0.1 wt %, an amount of the glycerol is 35˜40 wt %, an amount of the potassium chloride is 2.5˜3.0 wt %, and an amount of the deionized water is 28˜32 wt %.

5. The conductive hydrogel according to claim 1, further comprising at least one additive selected from the group consisting of a moisture-retaining agent, an enzyme, a surfactant, an antibiotic, a permeation enhancer, a pH adjuster, and mixtures thereof.

6. A method of preparing the conductive hydrogel of claim 1, comprising the steps of:
(I) mixing the first monomer, the second monomer, the crosslinking agent, the photoinitiator, the wetting agent and the electrolyte with the deionized water and stirring the mixture to prepare a composition; and
(II) irradiating the composition with ultraviolet to crosslink the composition.

7. The method according to claim 6, wherein, in the step (I) of preparing the composition, the crosslinking agent, the first monomer, the electrolyte, the wetting agent, the deionized water and the second monomer are sequentially mixed and stirred, and then the photoinitiator is added and stirred.
